(19) United States
(12) Patent Application Publication
(10) Pub. No.: US 2025/0133493 A1
(43) Pub. Date: Apr. 24, 2025

(54) UPLINK SIGNAL TRANSMISSION METHOD, TERMINAL, AND NETWORK SIDE DEVICE

(71) Applicant: VIVO MOBILE COMMUNICATION CO., LTD., Dongguan (CN)

(72) Inventors: Wei JIANG, Dongguan (CN); Gen LI, Dongguan (CN); Jianhui LI, Dongguan (CN); Qi HONG, Dongguan (CN)

(73) Assignee: VIVO MOBILE COMMUNICATION CO., LTD., Dongguan (CN)

(21) Appl. No.: 19/000,694

(22) Filed: Dec. 24, 2024

Related U.S. Application Data
(63) Continuation of application No. PCT/CN2023/102052, filed on Jun. 25, 2023.

(30) Foreign Application Priority Data
Jun. 29, 2022 (CN) 202210764850.3

(51) Int. Cl. H04W 52/02; H04L 5/00; H04W 24/10

(52) U.S. Cl. CPC H04W 52/0212; H04L 5/0053; H04W 24/10; H04W 52/0229

(57) ABSTRACT

This application provides an uplink signal transmission method, a terminal, and a network side device. The uplink signal transmission method includes: the terminal receives first information delivered by the network side device, and the terminal sends the second information to the network side device based on the first information. The first information indicates information related to sending of second information, and the second information indicates related information for assisting the network side device to save energy.

### CROSS-REFERENCE TO RELATED APPLICATIONS

This application is a continuation of International Application No. PCT/CN 2023/102052, filed on Jun. 25, 2023, which claims priority to Chinese Patent Application 202210764850.3, filed on Jun. 29, 2022. The entire contents of each of the above-referenced applications are expressly incorporated herein by reference.

### TECHNICAL FIELD

This application relates to the technical field of communications, and specifically, to an uplink signal transmission method, a terminal, and a network side device.

### BACKGROUND

A network side device such as a base station may enter an energy-saving state for an energy-saving purpose. For example, the base station reduces a transmission power of a common signal or disables a part of antennas to save energy. For example, the base station enters a sleep state or the energy-saving state in a case that the base station does not need to provide a service for a connected terminal, but some terminals in an idle state may require the base station to provide the service on some occasions, such as in a case of establishing a connection to the base station, and in this case, the base station is in the sleep state or the energy-saving state and cannot provide a normal service for the terminal.

### SUMMARY

Embodiments of this application provide an uplink signal transmission method, a terminal, and a network side device, to resolve a problem that a base station cannot provide a normal service for the terminal in a case that the base station is in a sleep or energy-saving state.

According to a first aspect, an uplink signal transmission method is provided, and includes:

A terminal receives first information delivered by a network side device, where the first information indicates information related to sending of second information, and the second information indicates related information for assisting the network side device to save energy.

The terminal sends the second information to the network side device based on the first information.

According to a second aspect, an uplink signal transmission method is provided, and includes:

A network side device sends first information to a terminal, where the first information indicates information related to sending of second information, and the second information indicates related information for assisting the network side device to save energy.

The network side device receives the second information sent by the terminal.

According to a third aspect, an uplink signal transmission apparatus is provided, and includes:
a receiving module, configured to receive first information delivered by a network side device, where the first information indicates information related to sending of second information, and the second information indicates related information for assisting the network side device to save energy; and
a sending module, configured to send the second information to the network side device based on the first information.

According to a fourth aspect, an uplink signal transmission apparatus is provided, and includes:
a sending module, configured to send first information to a terminal, where the first information indicates information related to sending of second information, and the second information indicates related information for assisting a network side device to save energy; and
a receiving module, configured to receive the second information sent by the terminal.

According to a fifth aspect, a terminal is provided. The terminal includes a processor and a memory, the memory stores a program or an instruction that is executable on the processor, and the program or the instruction is executed by the processor to implement the steps of the method according to the first aspect.

According to a sixth aspect, a terminal is provided, and includes a processor and a communication interface. The communication interface is configured to receive first information delivered by a network side device, where the first information indicates information related to sending of second information, and the second information indicates related information for assisting the network side device to save energy. The communication interface is further configured to send the second information to the network side device based on the first information.

According to a seventh aspect, a network side device is provided. The network side device includes a processor and a memory, the memory stores a program or an instruction that is executable on the processor, and the program or the instruction is executed by the processor to implement the steps of the method according to the second aspect.

According to an eighth aspect, a network side device is provided, and includes a processor and a communication interface. The communication interface is configured to send first information to a terminal, where the first information indicates information related to sending of second information, and the second information indicates related information for assisting the network side device to save energy. The communication interface is further configured to receive the second information sent by the terminal.

According to a ninth aspect, a communication system is provided, and includes a terminal and a network side device. The terminal may be configured to perform the steps of the uplink signal transmission method according to the first aspect, and the network side device may be configured to perform the steps of the uplink signal transmission method according to the second aspect.

According to a tenth aspect, a readable storage medium is provided. The readable storage medium stores a program or an instruction, and the program or the instruction is executed by a processor to implement the steps of the method according to the first aspect or the steps of the method according to the second aspect.

According to an eleventh aspect, a chip is provided. The chip includes a processor and a communication interface, the communication interface is coupled to the processor, and the processor is configured to run a program or an instruction to implement the method according to the first aspect or the method according to the second aspect.

According to a twelfth aspect, a computer program/program product is provided. The computer program/program product is stored in a storage medium, and the computer program/program product is executed by at least one processor to implement the steps of the uplink signal transmission method according to the first aspect or the second aspect.

In the embodiments of this application, the network side device sends the first information. Because the first information is the information related to sending of the second information, the first information may be used to notify the terminal to send the second information, where the second information may be used to assist the network side device to save the energy. In this way, the network side device may learn of presence of the terminal and further make a correct decision based on the second information sent by the terminal. Therefore, the network side device may provide the normal service for the terminal while the network side device is assisted to save the energy.

### BRIEF DESCRIPTION OF DRAWINGS

FIG. 1 is a structural diagram of a wireless communication system to which embodiments of this application may be applied;

FIG. 2 is a first schematic flowchart of an uplink signal transmission method according to an embodiment of this application;

FIG. 3 is a schematic interaction flowchart of an uplink signal transmission method according to an embodiment of this application;

FIG. 4 is a second schematic flowchart of an uplink signal transmission method according to an embodiment of this application;

FIG. 5 is a first schematic structural diagram of an uplink signal transmission apparatus according to an embodiment of this application;

FIG. 6 is a second schematic structural diagram of an uplink signal transmission apparatus according to an embodiment of this application;

FIG. 7 is a schematic structural diagram of a communication device according to an embodiment of this application;

FIG. 8 is a schematic structural diagram of hardware of a terminal according to an embodiment of this application; and

FIG. 9 is a schematic structural diagram of a network side device according to an embodiment of this application.

### DETAILED DESCRIPTION

The following clearly describes the technical solutions in embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the specification and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} Generation (6G) communication system.

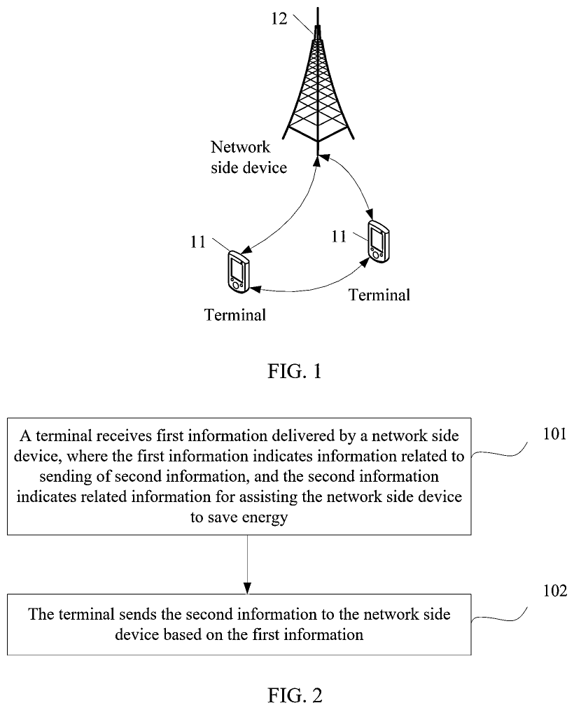

FIG. 1 is a block diagram of a wireless communication system to which embodiments of this application may be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home eNB, a Transmission Reception Point (TRP), or another appropriate term in the field. Provided that a same technical effect is achieved, the base station is not limited to a specified technical term. It should be noted that, in the embodiments of this application, only a base station in an NR system is used as an example for description, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

Related concepts in the embodiments of this application are first described.

RRC state:

An NR terminal may be in one of three RRC states: RRC_IDLE, RRC_CONNECTED, and RRC_INACTIVE. RRC_INACTIVE is a new state introduced in NR.

RRC_IDLE means that an RRC connection is not established between a terminal and a base station.

RRC_CONNECTED and RRC_INACTIVE mean that an RRC connection is established between the terminal and the base station.

In a 5G system, to further improve power-saving performance of the terminal, a Wake-Up Signal (WUS) based on a Physical Downlink Control Channel (PDCCH) is introduced. A function of the WUS is to notify the terminal whether a PDCCH needs to be monitored in onDuration of specific DRX. In a case that there is no data, the terminal may not need to monitor the PDCCH in the onDuration, which is equivalent to describing that the terminal may be in a sleep state in an entire DRX long cycle, to further save power.

The WUS signal is DCI, and is referred to as DCP (DCI with CRC scrambled by PS-RNTI) for short, where the PS-RNTI is an RNTI specially allocated by a network side device for the terminal to save power, and the DCI scrambled by the RNTI carries a wake-up/sleep indication of the network side device for the terminal. The terminal determines, based on the indication, whether to start an onDuration timer and whether to monitor the PDCCH in a next DRX cycle.

The terminal in the RRC_IDLE state can obtain a system message, and send a system message request messages without state transition, or receive a periodically broadcast system message.

In a network energy-saving technology, some base stations may be in an energy-saving state or sleep state. In these states, the base station may totally disable downlink sending; or only partially enable an uplink receiving function; or partially disable hardware, such as some antennas or antenna ports; or change a sending periodicity of a common signal (for example, prolonging the sending periodicity), to save energy.

In a method in the embodiments of this application, the network side device sends indication information to the terminal. The terminal determines, based on the received indication information, whether to trigger sending of an uplink signal to the network side device. In a case that the terminal sends the uplink signal to the network side device, the network side device may learn of presence of the terminal served by the network side device, and then perform a subsequent operation, to avoid affecting communication of the terminal.

The following describes in detail an uplink signal transmission method provided in the embodiments of this application by using some embodiments and application scenarios thereof with reference to the accompanying drawings.

FIG. 2 is a first schematic flowchart of an uplink signal transmission method according to an embodiment of this application. As shown in FIG. 2, the method provided in this embodiment includes the following steps.

Step 101: A terminal receives first information delivered by a network side device, where the first information indicates information related to sending of second information, and the second information indicates related information for assisting the network side device to save energy.

For example, to enable the network side device to learn of a served terminal, such as a terminal in an RRC_IDLE state, and to also enable the terminal to learn of a working state of the network side device, such as whether the network side device enters an energy-saving state or a sleep state, so that the terminal may perform a subsequent operation based on the working state of the network side device, for example, the terminal and the network side device establish a connection, the network side device sends the first information to the terminal to indicate the information related to sending of the second information, such as grouping information of the terminal sending the second information, indication information indicating whether to send the second information, and sending configuration information of the second information, such as a sending periodicity and a signal strength of the second information.

Step 102: The terminal sends the second information to the network side device based on the first information.

For example, the terminal determines, based on the first information, whether to send the second information to the network side device. For example, in a case that the terminal determines that the terminal is a terminal in a group indicated by the network side device, the terminal sends the second information. For example, the terminal may send the second information after the first information is received or at a time interval. For example, before the terminal determines that the terminal needs to establish the connection to the network side device, the terminal sends the second information to the network side device, so that the network side device does not enter the energy-saving state or the network side device in the energy-saving state is woken up. In this way, communication performance (such as a delay) of the terminal is not affected.

In the method in this embodiment, the network side device sends the first information. Because the first information is the information related to sending of the second information, the first information may be used to notify the terminal to send the second information, where the second information may be used to assist the network side device to save the energy. In this way, the network side device may learn of presence of the terminal and further make a correct decision based on the second information sent by the terminal. Therefore, the network side device may provide a normal service for the terminal while the network side device is assisted to save the energy.

In some embodiments, the first information includes at least one of the following information:
grouping information of the terminal;
first indication information, where the first indication information is used to trigger sending of the second information to the network side device;
sending configuration information of the second information;
power headroom of the network side device;
a signal transmission power of the network side device;
a decision threshold of a measurement result;
a target value range of the measurement result;
geographical location information; and
at least one first parameter, where the first parameter is used to determine the terminal sending the second information.

For example, the measurement result includes at least one of the following: an RSRP, RSRQ, a SINR, and the like. For example, in a case that the measurement result of the terminal fulfills the decision threshold or the value range, the terminal may send the second information. For example, in a case that the measurement result of the terminal is less than or equal to the decision threshold, or is within the value range, the terminal sends the second information to the network side device.

The decision threshold or the target value range may be predefined in a protocol or configured by the network side device.

In some embodiments, the decision threshold and/or the target value range may be predefined or configured with multiple values. For example, different values may be used in different scenarios.

For example, the geographical location information is a geographical area range, for example, represented by Global Positioning System (GPS) information.

The first parameter may be used to determine the terminal sending the second information. An example is provided below.

In a case that there are two first parameters whose values are m and k respectively, the terminal fulfilling m=terminal ID mod k sends the second information.

For example, the terminal that fulfills m=terminal ID mod k and whose measurement result of a latest measurement is within a specific value range or is less than a value of a specific decision threshold sends the second information.

For example, the terminal that fulfills m=terminal ID mod k and whose values of multiple continuous measurement results are within a specific value range or are less than (or equal to) a value of a specific decision threshold sends the second information.

In some embodiments, the grouping information includes at least one of the following:
a group identifier ID, an area ID, and a Synchronization Signal/PBCH Block (SSB) index.

In some embodiments, the grouping information is determined based on at least one of the following:
grouping based on the terminal ID;
grouping based on a distance between the terminal and the network side device;
grouping based on the measurement result of the terminal; and
grouping based on the SSB index.

For example, terminals may be pre-divided into N groups by using the grouping information based on at least one of the following, where at least one of the following may be predefined or configured by the network side device:

Grouping based on the terminal ID may be performed in, for example, at least one of the following manners:
divide terminals with a same value (terminal ID mod N) into a same group, where group ID=terminal ID mod N;
divide every N terminals into a same group in ascending order of terminal IDs; and
divide terminals with a same value (terminal ID/N) into a same group, for example, the value (terminal ID/N) may be a rounded value.

Grouping based on the distance between the terminal and the network side device serving the terminal may be performed in, for example, the following manner:
divide terminals into N groups based on distances between the terminals and the network side device, for example, divide terminals with 0 to 100 m, 100 m to 200 m, 200 m to 300 m, and 300 m to 400 m away from the network side device into four groups respectively; and
the terminal determines a group ID of the terminal based on a measured RSRP (for example, an RSRP of a synchronization signal/PBCH block SSB) and the foregoing grouping rule.

Grouping based on the measurement result of the terminal may be performed in, for example, the following manner:
divide terminals into N groups based on measurement results (for example, RSRPs) of the terminals for signals of the network side device, for example, divide terminals whose RSRPs are −80 dBm to −100 dBm, −100 dBm to −120 dBm, and −120 dBm to −140 dBm into three groups respectively; and
the terminal determines a group ID of the terminal based on a measured RSRP (for example, an RSRP of an SSB) and the foregoing grouping rule.

Grouping based on the SSB index is performed, for example, by using a Quasi Co-Location (QCL) relationship between an SSB and a signal/channel such as a PDCCH/Physical Downlink Shared Channel (PDSCH). For example, terminals with a same QCL relationship may be divided into one group. That is, these terminals are divided into one group in a case that an SSB with a specific index has a same QCL relationship with signals/channels such as PDCCHs/PDSCHs of specific terminals. In some embodiments, for example, terminals that have a same SSB index are divided into one group.

In the foregoing implementation, the network side device may indicate, by using at least one item in the first information, the information related to sending of the second information, which is more flexible, and the terminal that fulfills a specific condition may send the second information by configuring/modifying a parameter in the first information.

In some embodiments, step 102 may be implemented in the following manner:

The terminal sends the second information to the network side device in a case that the terminal fulfills a first condition, where the first condition includes at least one of the following:
the terminal learns that the working state of the network side device fulfills a second condition, where the second condition is that the working state of the network side device is to change from a non-energy-saving state to the energy-saving state or a state of the network side device is the energy-saving state;
the terminal receives the first information;
a first field is present in the first information received by the terminal, where the first field carries the grouping information;
a second field is present in the first information received by the terminal, where the second field carries the first indication information;
the terminal determines that grouping information carried in the first information includes the grouping information of the terminal;
a result of comparison between a measurement result of a latest measurement performed by the terminal and the decision threshold fulfills a third condition;
the measurement result of the latest measurement performed by the terminal is within the target value range of the measurement result; a result of comparison between a measurement result of X1 continuous measurements performed by the terminal and the decision threshold fulfills a third condition, where X1 is an integer greater than 0;
a measurement result of X2 continuous measurements performed by the terminal is within the target value range of the measurement result, where X2 is an integer greater than 0;
m is a value obtained by performing a modulo operation on a terminal ID and k, and m and k are respective values in a case that a quantity of the at least one first parameter is two;
a geographical location of the terminal is within a range of the geographical location information included in the first information;
a neighboring cell accessible to the terminal is absent; and
a neighboring cell fulfilling an access condition of the terminal is absent.

The latest measurement may mean a measurement with a minimum interval from a current moment.

In some embodiments, the working state includes at least one of the following: the sleep state, the energy-saving state, a normal state, or the non-energy-saving state.

The energy-saving state includes at least one of the following:
a state of disabling a downlink sending function, a state of disabling an uplink receiving function, a state of disabling a hardware unit, and a state of increasing a periodicity of a common signal.

The state of disabling the downlink sending function is, for example, to all or partially disable the downlink sending function.

The state of disabling the uplink receiving function is, for example, to all or partially disable the uplink receiving function. For example, a function of receiving uplink signaling is disabled.

The state of disabling the hardware unit is, for example, to all or partially disable the hardware unit. For example, the hardware unit includes at least one of the following: an antenna element, a transceiver unit TxRU, an antenna port, or a transmission reception point TRP. For example, the antenna port is an antenna port for sending a CSI-RS or an antenna port for sending a PDSCH.

In some embodiments, the third condition is that the measurement result is less than or equal to the decision threshold.

For example, in a case that the terminal learns that the working state of the network side device fulfills the second condition, for example, the terminal determines that the network side device is to enter the energy-saving state from the non-energy-saving state or is in the energy-saving state, the terminal may send the second information to the network side device.

In some embodiments, the working state of the network side device is learned of by the terminal from a system message or a message used to notify update of a system message.

For example, the terminal may learn of the working state of the network side device from update of a System Information Block (SIB), such as the update of the SIB notified by using paging DCI.

For example, in a case that the terminal receives the first information, or determines that the first field carrying the grouping information is present in the received first information or the second field carrying the first indication information is present in the received first information, sending of the second information to the network side device is triggered.

For example, in a case that the terminal determines that grouping information carried in a paging message includes the grouping information of the terminal, sending of the second information to the network side device is triggered.

For example, it is found that a group ID included in a paging record list (pagingRecordList) matches the group ID allocated to the terminal by a Non-Access Stratum (NAS).

For example, in a case that the terminal determines that grouping information carried in a paging message includes the grouping information of the terminal and an RSRP measurement result of a latest measurement is less than or equal to a value of a specific decision threshold, sending of the second information to the network side device is triggered.

For example, in a case that the terminal determines that grouping information carried in a paging message includes the grouping information of the terminal and an RSRP measurement result is less than a value of a specific decision threshold X1 continuous times, sending of the second information to the network side device is triggered.

In some embodiments, the measurement result is a measurement result of at least one of the following signals: the SSB, the SIB, the paging message, the physical downlink control channel PDCCH, or the physical downlink shared channel PDSCH.

In the foregoing implementation, the terminal may send the second information to the network side device based on at least one of the foregoing conditions, so that the network side device can learn of presence of the terminal and further make a subsequent decision, to avoid affecting communication of the terminal

In some embodiments, in a case that the first information carries the power headroom of the network side device, the method further includes:

The terminal determines, based on a measurement result of a latest measurement and the power headroom of the network side device, whether the signal transmission power of the network side device fulfills a terminal camping requirement.

The second information is not sent in a case that the terminal determines that the signal transmission power of the network side device does not fulfill the terminal camping requirement.

For example, in a case that the first information carries the power headroom of the network side device, the terminal determines, based on the measurement result (such as the RSRP) of the latest measurement and the power headroom, whether to send the second information. For example, in a case that the measurement result is less than a specific decision threshold, but even though the network side device uses all the power headroom for sending, the measurement result cannot be greater than the decision threshold, that is, the terminal camping requirement cannot be fulfilled, sending of the second information is not triggered.

The second information is sent in a case that the power headroom can fulfill the terminal camping requirement.

In some embodiments, the sending configuration information of the second information includes at least one of the following:
a minimum time interval between receiving time of the first information and sending time of the second information;
a quantity of times for repeatedly sending the second information;
a sending periodicity of the second information; and
a target sending signal strength of the second information.

For example, after determining whether to send the second information, the terminal may further send the second information based on the sending configuration information of the second information. For example, the terminal sends the second information based on the target sending signal strength, or periodically sends the second information based on the sending periodicity, or sends the second information N times based on the sending periodicity.

For example, the second information is sent in Y time units after the first information is received. Y is an integer greater than 0, and duration of the Y time units is greater than the minimum time interval.

The second information is sent at a second information sending moment with the minimum time interval after the first information is received.

The second information is sent repeatedly N times based on the sending periodicity, and N is less than or equal to the quantity of times for repeatedly sending.

A sending signal strength of the second information is greater than or equal to the target sending signal strength.

For example, the second information is sent in Y time units after paging DCI carrying the grouping information is received.

The second information is sent at a 1^{st} second information sending moment after paging DCI is received, that is, the second information is sent at a second information sending moment with the minimum time interval after paging DCI is received.

The second information is sent by using a sending signal strength greater than the target sending signal strength. The target sending signal strength is, for example, equal to the signal transmission power, such as Z dBm.

In some embodiments, the time unit may be a symbol, a slot, a subframe, a frame, a second (s), or a millisecond (ms).

In some embodiments, in addition to being carried in the first information, the sending configuration information of the second information may be obtained in at least one of the following manners:
configured by using at least one of a Radio Resource Control (RRC) message, a Media Access Control (MAC) Control Element (CE), or a system message in a serving cell or a tracking area of the terminal; and
updated by using a system message.

For example, in a case that the first information does not include the sending configuration information of the second information, the sending configuration information of the second information may be configured in another manner, for example, configured by the network side device to the terminal in the serving cell or the tracking area of the terminal, or configured by using at least one of the radio resource control RRC message, the MAC CE, or the system message. For example, the sending configuration information of the second information may be updated by using the system message such as a SIB.

In some embodiments, the first information is carried in at least one of the following:
a paging message, paging downlink control information DCI, a synchronization signal/PBCH block SSB, a system information block SIB, a group common PDCCH, and DCI in a broadcast form.

The DCI in the broadcast form may be DCI in an existing broadcast form or DCI in a newly defined broadcast form.

In some embodiments, the grouping information is carried in a reserved bit in DCI or a target field in a paging message, where the target field includes at least one of the following: a paging field, a paging record field, or a paging terminal identifier.

For example, the grouping information is carried in the reserved bit in the paging DCI. The field may implicitly indicate to send the second information to the network side device, that is, presence of the grouping information field indicates that the second information needs to be sent to the network side device, and/or indicates a specific terminal and/or terminal group sending the second information to the network side device. For example, the grouping information such as the group ID is carried in the paging message.

The paging message may be used for implicit indication, for example, in the following several manners:

The grouping information (such as a group-Identity) is carried in the paging field, for example:

| | | |
|---|---|---|
| Paging ::= | SEQUENCE { | |
| pagingRecordList | PagingRecordList | OPTIONAL, -- Need N |
| lateNonCriticalExtension | OCTET STRING | OPTIONAL, |
| nonCriticalExtension | SEQUENCE{ } | OPTIONAL |
| group-Identity | | OPTIONAL |
| } | | |

For example, the grouping information (such as the group-Identity) is carried in the PagingRecord field, for example:

| | |
|---|---|
| PagingRecord ::= | SEQUENCE { |
| ue-Identity | PagingUE-Identity, |
| accessType | ENUMERATED {non3GPP} OPTIONAL, -- Need N |
| group-Identity | |
| ... | |
| } | |

For example, an option (group-Identity) is added to the PagingUE-Identity field, for example:

| | |
|---|---|
| PagingUE-Identity ::= | CHOICE { |
| ng-5G-S-TMSI | NG-5G-S-TMSI, |
| fullI-RNTI | I-RNTI-Value, |
| group-Identity | groupID-Value OPTIONAL, |
| ... | |
| } | |

For example, the grouping information and the first indication information may be carried in the paging message for explicit indication.

For example, the explicit indication may be performed in the following manner:

The first indication information is carried in a short message indicator field in the paging DCI, for example, a reserved value ‘00’ in the short message indicator field indicates that sending of the second information to the network side device is triggered; or
the first indication information is carried in a reserved bit in the DCI in the broadcast form, for example, the DCI in the existing broadcast form or the newly defined DCI; or
the first indication information is carried in the paging message.

In the foregoing implementation, the terminal is indicated in multiple manners, and the terminal determines whether to send the second information. In this way, implementation of the terminal is low in complexity and high in flexibility.

In some embodiments, the second information carries at least one of the following:
wake-up indication information, where the wake-up indication information indicates whether to wake up the network side device in the energy-saving state;
the terminal ID;
location information of the terminal;
a signal transmission power that is of the network side device and that is expected by the terminal;
a transmit beam that is of the network side device and that is expected by the terminal;
a transmission power of the terminal;
service-related information; and
user experience-related information.

For example, the wake-up indication information may be represented by preset code. For example, bits “00” indicate not to wake up the network side device, and bits “01” indicate to wake up the network side device.

For example, the terminal ID includes a GUTI or a TMSI. For example, the network side device may count, based on the terminal ID, a quantity of times that second information is received from a same terminal or a quantity of times that second information is received from multiple terminals.

The location information of the terminal may be used by the network side device to determine whether to perform a corresponding target behavior, such as adjusting a working state. For example, the corresponding target behavior is performed in a case of determining that the terminal is within a target area.

For example, the service-related information includes at least one of the following: a Packet Delay Budget (PDB), a data packet size, a service cycle, a priority, and the like. For example, the user experience-related information includes at least one of the following: a transmission delay, a throughput, an experience rate, and the like.

For example, after learning of the foregoing information, the network side device may perform a corresponding operation, such as changing from the energy-saving state to the non-energy-saving state or increasing the signal transmission power. For example, in a case that the service-related information sent by the terminal is the packet delay budget PDB, the network side device may adjust the signal transmission power and the like based on the information, to fulfill a requirement of the service-related information.

For example, the network side device may adjust a downlink signal transmission power based on the transmission power of the terminal and a measurement result of a signal sent by the terminal. For example, an uplink signal path loss may be estimated based on the transmission power of the terminal and a signal measurement result RSRP of the second information, and the downlink signal transmission power may be adjusted to an appropriate signal transmission power, to provide a better service for the terminal.

In some embodiments, the signal transmission power of the network side device is a transmission power of at least one of the following signals: an SSB, a SIB, a paging message, a channel state information reference signal CSI-RS, a PDCCH, and a PDSCH.

In the foregoing implementation, an indication is sent to the network side device by using at least one item in the second information, so that the network side device learns of the presence of the terminal, to reduce impact on communication performance of the terminal, and the network side device may be assisted, based on the second information, to perform an energy-saving-related operation.

In some embodiments, the second information is carried in at least one of the following:
a wake-up signal WUS, a Physical Uplink Control Channel (PUCCH), a Physical Random Access Channel (PRACH), and a preamble sequence. The preamble sequence may be, for example, a preamble sequence in a specific format.

In some embodiments, after step 102, the method further includes:

The terminal executes a cell reselection procedure in a case that the terminal detects that a measurement result of the network side device is less than or equal to the decision threshold M continuous times, where M is an integer greater than 0.

For example, in a case that the terminal fails to wake up the network side device, for example, the measurement result of the network side device is less than or equal to the decision threshold M continuous times, or is within the target value range of the measurement result, it indicates that the current network side device cannot provide a service for the terminal, and the terminal needs to access another network side device, that is, the terminal performs the cell reselection procedure to find a new cell to access. Otherwise, the terminal continues to camp on a current serving cell.

In the foregoing implementation, in the case that the terminal detects that the measurement result of the network side device is less than or equal to the decision threshold M continuous times, the terminal may re-select the cell to access, to avoid affecting the communication performance of the terminal

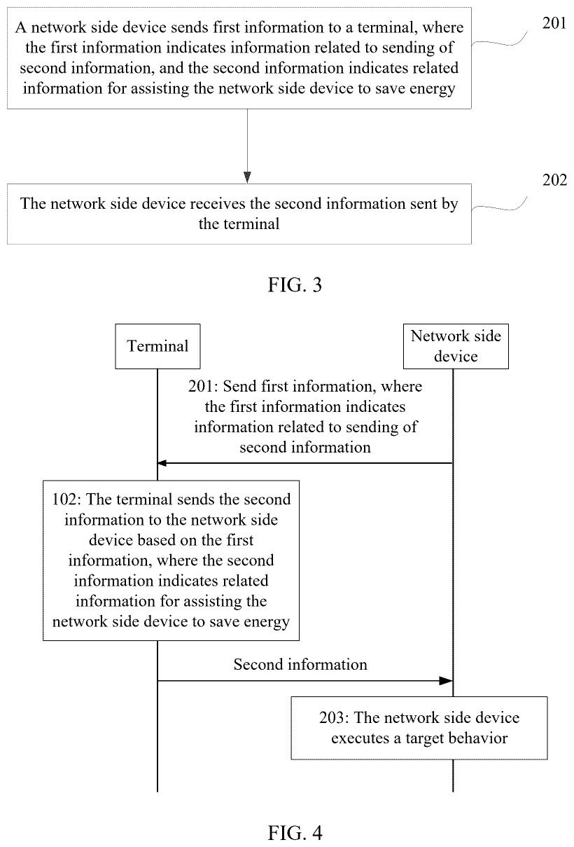

FIG. 3 is a second schematic flowchart of an uplink signal transmission method according to an embodiment of this application. As shown in FIG. 3, the method provided in this embodiment includes the following steps.

Step 201: A network side device sends first information to a terminal, where the first information indicates information related to sending of second information, and the second information indicates related information for assisting the network side device to save energy.

Step 202: The network side device receives the second information sent by the terminal.

In some embodiments, the network side device sends the first information to the terminal in a case that at least one of the following target conditions is fulfilled:
the network side device periodically sends the first information;
the network side device sends the first information within a target time domain position range;
in X4 time units before a working state of the network side device changes to an energy-saving state, N1 times of sending the first information are triggered, where X4 and N1 are integers greater than or equal to 0;
in X3 time units after the working state of the network side device changes to the energy-saving state, N2 times of sending the first information are triggered, where X3 and N2 are integers greater than or equal to 0;
sending of the first information is started in a case that a signal transmission power of the network side device is less than or equal to a first power threshold; and
sending of the first information is started in a case that a quantity of target units disabled by the network side device is less than or equal to a first quantity threshold.

In some embodiments, the target unit includes at least one of the following: an antenna element, a transceiver unit TxRU, an antenna port, or a transmission reception point TRP.

For example, the network side device periodically sends the first information, and a sending periodicity may be predefined in a protocol or pre-configured.

The network side device sends the first information within the target time domain position range, such as, on a 1^{st} symbol in each slot or a 1^{st} subframe in each frame, and the target time domain position is predefined or pre-configured.

For example, the first information is continuously sent for specific duration and/or a specific quantity of times. For example, sending of N1 times of the first information is triggered in X4 time units before the network side device enters the energy-saving state.

For example, sending of N2 times of the first information is triggered in X3 time units before the network side device enters the energy-saving state.

Sending of the first information is started after the signal transmission power of the network side device is reduced to a specific value, for example, less than or equal to the first power threshold.

Sending of the first information is started after a quantity of antenna elements, TxRUs, antenna ports, or Transmission Receiving Point (TRP) disabled by the network side device reaches a specific threshold, for example, is less than or equal to the first quantity threshold.

In some embodiments, the working state includes at least one of the following:
a sleep state, the energy-saving state, a normal state, or a non-energy-saving state.

The energy-saving state includes at least one of the following:
a state of disabling or partially disabling a downlink sending function, a state of disabling or partially disabling an uplink receiving function, a state of disabling or partially disabling a hardware unit, and a state of increasing a periodicity of a common signal.

In some embodiments, as shown in FIG. 4, after the second information sent by the terminal is received, the method further includes the following step.

Step 203: The network side device executes a target behavior, where the target behavior includes at least one of the following:
adjusting the working state;
adjusting the signal transmission power; and
stopping sending the first information.

For example, adjusting the working state, is for example, adjusting from the sleep state to the normal state or the non-energy-saving state, or adjusting from the non-energy-saving state to a state of partially disabling an antenna or the antenna port, or the state of increasing the periodicity of the common signal.

For example, a signal transmission power of a signal such as an SSB, a SIB, a paging message, a CSI-RS, a PDCCH, or a PDSCH may be adjusted, for example, the signal transmission power is increased or decreased.

In some embodiments, that the network side device stops sending the first information includes:

The network side device stops sending the first information in a case that at least one of the following conditions is fulfilled:
the first information is sent continuously for first duration and/or M1 times, and the second information is not received;
the second information is received; and
the first information is sent repeatedly N3 times.

For example, in a case that a quantity of times of periodically sending the first information is greater than or equal to a specific threshold, for example, the first information has been sent repeatedly N3 times, sending stops.

For example, in a case that the first information is continuously sent for the first duration and/or M1 times, and the second information of the terminal is not received, sending stops, and the energy-saving state may be further entered.

For example, in a case that receiving second information sent by any terminal, sending stops.

In the foregoing implementation, to reduce power consumption of the network side device and reduce a waste of resources, sending of the first information may be stopped in the foregoing cases.

In some embodiments,
that the network side device executes a target behavior includes:

The network side device executes the target behavior in a case that the following condition is fulfilled:
the network side device receives second information sent by any terminal;
the network side device receives the second information greater than or equal to M2 times within second duration;
a quantity of times that the network side device receives second information from a same terminal within third duration is greater than or equal to M3 times; or
the network side device receives second information from greater than or equal to M4 different terminals within fourth duration.

The second duration, the third duration, and the fourth duration may be predefined in a protocol or pre-configured.

The second information is received greater than or equal to M2 times within the second duration, and the second information may be sent by one or more terminals.

In some embodiments, the first information includes at least one of the following information:
grouping information of the terminal;
first indication information, where the first indication information is used to trigger sending of the second information to the network side device;
sending configuration information of the second information;
power headroom of the network side device;
the signal transmission power of the network side device;
a decision threshold of a measurement result;
a target value range of the measurement result;
geographical location information; and
at least one first parameter, where the first parameter is used to determine the terminal sending the second information.

In some embodiments, the grouping information includes at least one of the following:
a group identifier ID, an area ID, and a synchronization signal/PBCH block SSB index.

In some embodiments, the grouping information is determined based on at least one of the following:
grouping based on a terminal ID;
grouping based on a distance between the terminal and the network side device;
grouping based on a measurement result of the terminal; and
grouping based on an SSB index.

In some embodiments, the sending configuration information of the second information includes at least one of the following:
a minimum time interval between receiving time of the first information and sending time of the second information;
a quantity of times for repeatedly sending the second information;
a sending periodicity of the second information; and
a target sending signal strength of the second information.

In some embodiments, the second information carries at least one of the following:
wake-up indication information, where the wake-up indication information indicates whether to wake up the network side device in the energy-saving state;
the terminal ID;
location information of the terminal;
a signal transmission power that is of the network side device and that is expected by the terminal;
a transmit beam that is of the network side device and that is expected by the terminal;
a transmission power of the terminal;
service-related information; and
user experience-related information, where
the service-related information includes at least one of the following: a packet delay budget PDB, a data packet size, a service cycle, and a priority, and the user experience-related information includes at least one of the following: a transmission delay, a throughput, and an experience rate.

A specific implementation process and technical effects of the method in this embodiment are the same as those in the method embodiment on the terminal side. For details, refer to the detailed descriptions in the method embodiment on the terminal side. Details are not described herein again.

The uplink signal transmission method provided in the embodiments of this application may be performed by an uplink signal transmission apparatus. The uplink signal transmission apparatus provided in the embodiments of this application is described by using an example in which the uplink signal transmission apparatus performs the uplink signal transmission method in the embodiments of this application.

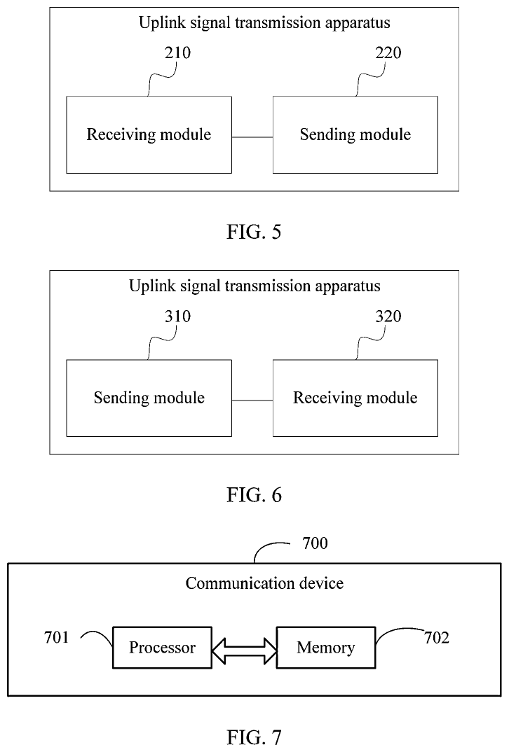

FIG. 5 is a first schematic structural diagram of an uplink signal transmission apparatus according to an embodiment of this application. As shown in FIG. 5, the uplink signal transmission apparatus provided in this embodiment includes:
a receiving module 210, configured to receive first information delivered by a network side device, where the first information indicates information related to sending of second information, and the second information indicates related information for assisting the network side device to save energy; and
a sending module 220, configured to send the second information to the network side device based on the first information.

In some embodiments, the first information includes at least one of the following information:
grouping information of the terminal;
first indication information, where the first indication information is used to trigger sending of the second information to the network side device;
sending configuration information of the second information;
power headroom of the network side device;
a signal transmission power of the network side device;
a decision threshold of a measurement result;
a target value range of the measurement result;
geographical location information; and
at least one first parameter, where the first parameter is used to determine the terminal sending the second information.

In some embodiments, the grouping information includes at least one of the following:
a group identifier ID, an area ID, and an SSB index.

In some embodiments, the grouping information is determined based on at least one of the following:
grouping based on a terminal ID;
grouping based on a distance between the terminal and the network side device;
grouping based on a measurement result of the terminal; and
grouping based on the SSB index.

In some embodiments, that the terminal sends the second information to the network side device based on the first information includes:

The terminal sends the second information to the network side device in a case that the terminal fulfills a first condition, where the first condition includes at least one of the following:
the terminal learns that a working state of the network side device fulfills a second condition, where the second condition is that the working state of the network side device is to change from a non-energy-saving state to an energy-saving state or a state of the network side device is an energy-saving state;
the terminal receives the first information;
a first field is present in the first information received by the terminal, where the first field carries the grouping information;
a second field is present in the first information received by the terminal, where the second field carries the first indication information;
the terminal determines that grouping information carried in the first information includes the grouping information of the terminal;
a result of comparison between a measurement result of a latest measurement performed by the terminal and the decision threshold fulfills a third condition;
the measurement result of the latest measurement performed by the terminal is within the target value range of the measurement result; a result of comparison between a measurement result of X1 continuous measurements performed by the terminal and the decision threshold fulfills a third condition, where X1 is an integer greater than 0;
a measurement result of X2 continuous measurements performed by the terminal is within the target value range of the measurement result, where X2 is an integer greater than 0;
a quantity of times or a proportion that a result of comparison between a measurement result of a measurement performed by the terminal within a first target time range and the decision threshold fulfills the third condition is greater than or equal to a first threshold;
a quantity of times or a proportion that a measurement result of a measurement performed by the terminal within a second target time range is within the target value range of the measurement result is greater than or equal to a second threshold;
m is a value obtained by performing a modulo operation on a terminal ID and k, and m and k are respective values in a case that a quantity of the at least one first parameter is two; a geographical location of the terminal is within a range of the geographical location information included in the first information;
a neighboring cell accessible to the terminal is absent; and
a neighboring cell fulfilling an access condition of the terminal is absent.

In some embodiments, the second condition is that the working state of the network side device is to change from the non-energy-saving state to the energy-saving state or the state of the network side device is the energy-saving state.

In some embodiments, the third condition is that the measurement result is less than or equal to the decision threshold, and the measurement result is a measurement result of at least one of the following signals: an SSB, a system information block SIB, a paging message, a physical downlink control channel PDCCH, or a physical downlink shared channel PDSCH.

In some embodiments, in a case that the first information carries the power headroom of the network side device, the method further includes:
the terminal determines, based on a measurement result of a latest measurement and the power headroom of the network side device, whether the signal transmission power of the network side device fulfills a terminal camping requirement; and
skips sending the second information in a case that the terminal determines that the signal transmission power of the network side device does not fulfill the terminal camping requirement.

In some embodiments, the sending configuration information of the second information includes at least one of the following:
a minimum time interval between receiving time of the first information and sending time of the second information;
a quantity of times for repeatedly sending the second information;
a sending periodicity of the second information; and
a target sending signal strength of the second information.

In some embodiments, the sending configuration information of the second information is obtained in at least one of the following manners:
configured by using at least one of a radio resource control RRC message, a media access control element MAC CE, or a system message in a serving cell or a tracking area of the terminal;
updated by using a system message; and
carried in the first information.

In some embodiments, the second information carries at least one of the following:
wake-up indication information, where the wake-up indication information indicates whether to wake up the network side device in the energy-saving state;
the terminal ID;
location information of the terminal;
a signal transmission power that is of the network side device and that is expected by the terminal;
a transmit beam that is of the network side device and that is expected by the terminal;
a transmission power of the terminal;
service-related information; and
user experience-related information, where
the service-related information includes at least one of the following: a packet delay budget PDB, a data packet size, a service cycle, and a priority, and the user experience-related information includes at least one of the following: a transmission delay, a throughput, and an experience rate.

In some embodiments, the signal transmission power is a transmission power of at least one of the following signals: an SSB, a SIB, a paging message, a channel state information reference signal CSI-RS, a PDCCH, and a PDSCH.

In some embodiments, after the terminal sends the second information, the method further includes:

The terminal executes a cell reselection procedure in a case that the terminal detects that a measurement result of the network side device is less than or equal to the decision threshold M continuous times, where M is an integer greater than 0.

In some embodiments, the working state of the network side device is learned of by the terminal from a system message or a message used to notify update of a system message.

In some embodiments, the first information is carried in at least one of the following:
a paging message, paging downlink control information DCI, a synchronization signal/PBCH block SSB, a system information block SIB, a group common PDCCH, and DCI in a broadcast form.

In some embodiments, the second information is carried in at least one of the following:
a wake-up signal WUS, a physical uplink control channel PUCCH, a physical random access channel PRACH, and a preamble sequence.

In some embodiments, the grouping information is carried in a reserved bit in DCI or a target field in a paging message, where the target field includes at least one of the following: a paging field, a paging record field, or a paging terminal identifier.

In some embodiments, the first indication information is carried in at least one of the following manners:
a reserved bit in DCI in a broadcast form;
a reserved value in a short message indicator field in paging DCI; and
a paging message.

The apparatus in this embodiment may be configured to perform the method in any one of the method embodiments on the terminal side. A specific implementation process and technical effects of the apparatus are the same as those in the method embodiment on the terminal side. For details, refer to the detailed descriptions in the method embodiment on the terminal side. Details are not described herein again.

FIG. 6 is a second schematic structural diagram of an uplink signal transmission apparatus according to an embodiment of this application. As shown in FIG. 6, the uplink signal transmission apparatus provided in this embodiment includes:
a sending module 310, configured to send first information to a terminal, where the first information indicates information related to sending of second information, and the second information indicates related information for assisting a network side device to save energy; and
a receiving module 320, configured to receive the second information sent by the terminal.

In some embodiments, the sending module 310 is configured to perform at least one of the following:
periodically sending the first information;
sending the first information within a target time domain position range;
in X4 time units before a working state of the network side device changes to an energy-saving state, triggering N1 times of sending the first information, where X4 and N1 are integers greater than or equal to 0;
in X3 time units after the working state of the network side device changes to the energy-saving state, triggering N2 times of sending the first information, where X3 and N2 are integers greater than or equal to 0;
starting sending the first information in a case that a signal transmission power of the network side device is less than or equal to a first power threshold; and
starting sending the first information in a case that a quantity of target units disabled by the network side device is less than or equal to a first quantity threshold.

In some embodiments, the target unit includes at least one of the following: an antenna element, a transceiver unit TxRU, an antenna port, or a transmission reception point TRP.

In some embodiments, the apparatus further includes:
a processing module, configured to: after the second information sent by the terminal is received, perform a target behavior, where the target behavior includes at least one of the following:
adjusting the working state;
adjusting the signal transmission power; and
stopping sending the first information.

In some embodiments, the processing module is configured to:
stop sending the first information in a case that at least one of the following conditions is fulfilled:
continuously send the first information for first duration and/or M1 times, and skip receiving the second information;
receive the second information; and
repeatedly send the first information N3 times.

In some embodiments, the working state includes at least one of the following: a sleep state, the energy-saving state, a normal state, and a non-energy-saving state.

In some embodiments, the energy-saving state includes at least one of the following:
a state of disabling or partially disabling a downlink sending function, a state of disabling or partially disabling an uplink receiving function, a state of disabling or partially disabling a hardware unit, and a state of increasing a periodicity of a common signal.

In some embodiments, the processing module is configured to:
execute the target behavior in a case that the following condition is fulfilled:
second information sent by any terminal is received;
the second information is received greater than or equal to M2 times within second duration;
a quantity of times that second information is received from a same terminal within third duration is greater than or equal to M3 times; or
second information is received from greater than or equal to M4 different terminals within fourth duration.

In some embodiments, the first information includes at least one of the following information:
grouping information of the terminal;
first indication information, where the first indication information is used to trigger sending of the second information to the network side device;
sending configuration information of the second information;
power headroom of the network side device;
the signal transmission power of the network side device;
a decision threshold of a measurement result;
a target value range of the measurement result;
geographical location information; and
at least one first parameter, where the first parameter is used to determine the terminal sending the second information.

In some embodiments, the grouping information includes at least one of the following:
a group identifier ID, an area ID, and a synchronization signal/PBCH block SSB index.

In some embodiments, the grouping information is determined based on at least one of the following:
grouping based on a terminal ID;
grouping based on a distance between the terminal and the network side device;
grouping based on a measurement result of the terminal; and
grouping based on an SSB index.

In some embodiments, the sending configuration information of the second information includes at least one of the following:
a minimum time interval between receiving time of the first information and sending time of the second information;
a quantity of times for repeatedly sending the second information;
a sending periodicity of the second information; and a target sending signal strength of the second information.

In some embodiments, the second information carries at least one of the following:
wake-up indication information, where the wake-up indication information indicates whether to wake up the network side device in the energy-saving state;
the terminal ID;
location information of the terminal;
a signal transmission power that is of the network side device and that is expected by the terminal;
a transmit beam that is of the network side device and that is expected by the terminal;
a transmission power of the terminal;
service-related information; and
user experience-related information, where
the service-related information includes at least one of the following: a packet delay budget PDB, a data packet size, a service cycle, and a priority, and the user experience-related information includes at least one of the following: a transmission delay, a throughput, and an experience rate.

The apparatus in this embodiment may be configured to perform the method in any one of the method embodiments on the network side. A specific implementation process and technical effects of the apparatus are the same as those in the method embodiment on the network side. For details, refer to the detailed descriptions in the method embodiment on the network side. Details are not described herein again.

The uplink signal transmission apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11. The another device may be a server, a Network Attached Storage (NAS), or the like. This is not specifically limited in this embodiment of this application.

The uplink signal transmission apparatus provided in this embodiment of this application can implement the processes implemented in the method embodiments in FIG. 2 to FIG. 4, and a same technical effect can be achieved. To avoid repetition, details are not described herein again.

In some embodiments, as shown in FIG. 7, an embodiment of this application further provides a communication device 700, including a processor 701 and a memory 702. The memory 702 stores a program or an instruction that is executable on the processor 701. For example, in a case that the communication device 700 is a terminal, the program or the instruction is executed by the processor 701 to implement the steps of the foregoing embodiment of the uplink signal transmission method, and a same technical effect can be achieved. In a case that the communication device 700 is a network side device, the program or the instruction is executed by the processor 701 to implement the steps of the foregoing embodiment of the uplink signal transmission method, and a same technical effect can be achieved. To avoid repetition, details are not described herein again.

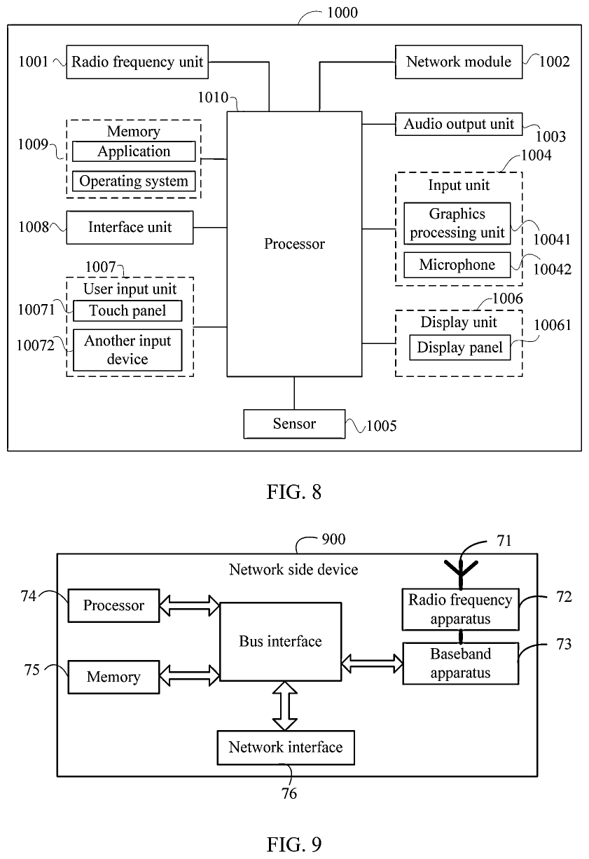

An embodiment of this application further provides a terminal, including a processor and a communication interface. The communication interface is configured to receive first information delivered by a network side device, where the first information indicates information related to sending of second information, and the second information indicates related information for assisting the network side device to save energy. The communication interface is further configured to send the second information to the network side device based on the first information. The terminal embodiment corresponds to the terminal side method embodiment, each implementation process and implementation of the method embodiment can be applied to the terminal embodiment, and a same technical effect can be achieved. For example, FIG. 8 is a schematic structural diagram of hardware of a terminal according to an embodiment of this application.

The terminal 1000 includes but is not limited to at least some components in a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the terminal 1000 may further include a power supply (such as a battery) that supplies power to each component. The power supply may be logically connected to the processor 1010 by using a power supply management system, to implement functions such as charging and discharging management, and power consumption management by using the power supply management system. The terminal structure shown in FIG. 8 constitutes no limitation on the terminal, and the terminal may include more or fewer components than those shown in the figure, or combine some components, or have different component arrangements. Details are not described herein.

It should be understood that in this embodiment of this application, the input unit 1004 may include a Graphics Processing Unit (GPU) 10041 and a microphone 10042. The graphics processing unit 10041 processes image data of a static picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include, but is not limited to, a physical keyboard, a function key (such as a volume control key or an on/off key), a trackball, a mouse, and a joystick. Details are not described herein again.

In this embodiment of this application, the radio frequency unit 1001 receives downlink data from a network side device and then sends the downlink data to the processor 1010 for processing; and the radio frequency unit 1001 may send uplink data to the network side device. Usually, the radio frequency unit 1001 includes but is not limited to an antenna, at least one amplifier, a transceiver, a coupler, a low noise amplifier, a duplexer, and the like.

The memory 1009 may be configured to store a software program or an instruction and various data. The memory 1009 may mainly include a first storage area for storing a program or an instruction and a second storage area for storing data. The first storage area for the program or the instruction may store an operating system, and an application or an instruction required by at least one function (for example, a sound playing function or an image playing function). In addition, the memory 1009 may be a volatile memory or a non-volatile memory, or the memory 1009 may include both a volatile memory and a non-volatile memory. The memory includes a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1009 in this embodiment of this application includes but is not limited to these memories and any memory of another proper type, for example, at least one disk storage device, a flash memory device, or other non-volatile solid state storage devices.

The processor 1010 may include one or more processing units. In some embodiments, an application processor and a modem processor may be integrated into the processor 1010. The application processor mainly processes an operating system, a user interface, an application or instruction, or the like. The modem processor mainly processes a wireless communication signal, for example, a baseband processor. It may be understood that, in some embodiments, the modem processor may not be integrated into the processor 1010.

The radio frequency unit 1001 is configured to receive first information delivered by a network side device, where the first information indicates information related to sending of second information, and the second information indicates related information for assisting the network side device to save energy.

The radio frequency unit 1001 is further configured to send the second information to the network side device based on the first information.

In the foregoing implementation, the network side device sends the first information. Because the first information is the information related to sending of the second information, the first information may be used to notify the terminal to send the second information, where the second information may be used to assist the network side device to save the energy. In this way, the network side device may learn of presence of the terminal and further make a correct decision based on the second information sent by the terminal. Therefore, the network side device may provide a normal service for the terminal while the network side device is assisted to save the energy.

In some embodiments, the first information includes at least one of the following information:
grouping information of the terminal;
first indication information, where the first indication information is used to trigger sending of the second information to the network side device;
sending configuration information of the second information;
power headroom of the network side device;
a signal transmission power of the network side device;
a decision threshold of a measurement result;
a target value range of the measurement result;
geographical location information; and
at least one first parameter, where the first parameter is used to determine the terminal sending the second information.

In some embodiments, the grouping information includes at least one of the following:
a group identifier ID, an area ID, and an SSB index.

In some embodiments, the grouping information is determined based on at least one of the following:
grouping based on a terminal ID;
grouping based on a distance between the terminal and the network side device;
grouping based on a measurement result of the terminal; and
grouping based on the SSB index.

In some embodiments, the radio frequency unit 1001 is configured to:
send the second information to the network side device in a case that the terminal fulfills a first condition, where the first condition includes at least one of the following:
the terminal learns that a working state of the network side device fulfills a second condition, where the second condition is that the working state of the network side device is to change from a non-energy-saving state to an energy-saving state or a state of the network side device is an energy-saving state;
the terminal receives the first information;
a first field is present in the first information received by the terminal, where the first field carries the grouping information;
a second field is present in the first information received by the terminal, where the second field carries the first indication information;
the terminal determines that grouping information carried in the first information includes the grouping information of the terminal;
a result of comparison between a measurement result of a latest measurement performed by the terminal and the decision threshold fulfills a third condition;
the measurement result of the latest measurement performed by the terminal is within the target value range of the measurement result; a result of comparison between a measurement result of X1 continuous measurements performed by the terminal and the decision threshold fulfills a third condition, where X1 is an integer greater than 0;
a measurement result of X2 continuous measurements performed by the terminal is within the target value range of the measurement result, where X2 is an integer greater than 0;
a quantity of times or a proportion that a result of comparison between a measurement result of a measurement performed by the terminal within a first target time range and the decision threshold fulfills the third condition is greater than or equal to a first threshold;
a quantity of times or a proportion that a measurement result of a measurement performed by the terminal within a second target time range is within the target value range of the measurement result is greater than or equal to a second threshold;
m is a value obtained by performing a modulo operation on a terminal ID and k, and m and k are respective values in a case that a quantity of the at least one first parameter is two;
a geographical location of the terminal is within a range of the geographical location information included in the first information;
a neighboring cell accessible to the terminal is absent; and
a neighboring cell fulfilling an access condition of the terminal is absent.

In some embodiments, the second condition is that the working state of the network side device is to change from the non-energy-saving state to the energy-saving state or the state of the network side device is the energy-saving state.

In some embodiments, the third condition is that the measurement result is less than or equal to the decision threshold, and the measurement result is a measurement result of at least one of the following signals: an SSB, a SIB, a paging message, a physical downlink control channel PDCCH, or a physical downlink shared channel PDSCH.

In some embodiments, in a case that the first information carries the power headroom of the network side device, the radio frequency unit 1001 is further configured to:
determine, based on a measurement result of a latest measurement and the power headroom of the network side device, whether the signal transmission power of the network side device fulfills a terminal camping requirement; and
skip sending the second information in a case that the terminal determines that the signal transmission power of the network side device does not fulfill the terminal camping requirement.

In some embodiments, the sending configuration information of the second information includes at least one of the following:
a minimum time interval between receiving time of the first information and sending time of the second information;
a quantity of times for repeatedly sending the second information;
a sending periodicity of the second information; and
a target sending signal strength of the second information.

In some embodiments, the sending configuration information of the second information is obtained in at least one of the following manners:
configured by using at least one of a radio resource control RRC message, a media access control element MAC CE, or a system message in a serving cell or a tracking area of the terminal;
updated by using a system message; and
carried in the first information.

In some embodiments, the second information carries at least one of the following:
wake-up indication information, where the wake-up indication information indicates whether to wake up the network side device in the energy-saving state;
the terminal ID;
location information of the terminal;
a signal transmission power that is of the network side device and that is expected by the terminal;
a transmit beam that is of the network side device and that is expected by the terminal;
a transmission power of the terminal;
service-related information; and
user experience-related information, where
the service-related information includes at least one of the following: a packet delay budget PDB, a data packet size, a service cycle, and a priority, and the user experience-related information includes at least one of the following: a transmission delay, a throughput, and an experience rate.

In some embodiments, the signal transmission power is a transmission power of at least one of the following signals: an SSB, a SIB, a paging message, a channel state information reference signal CSI-RS, a PDCCH, and a PDSCH.

In some embodiments, the processor 1010 is configured to:
execute a cell reselection procedure in a case of detecting that a measurement result of the network side device is less than or equal to the decision threshold M continuous times, where M is an integer greater than 0.

In some embodiments, the working state of the network side device is learned of by the terminal from a system message or a message used to notify update of a system message.

In some embodiments, the first information is carried in at least one of the following:
a paging message, paging downlink control information DCI, a synchronization signal/PBCH block SSB, a system information block SIB, a group common PDCCH, and DCI in a broadcast form.

In some embodiments, the second information is carried in at least one of the following:
a wake-up signal WUS, a physical uplink control channel PUCCH, a physical random access channel PRACH, and a preamble sequence.

In some embodiments, the grouping information is carried in a reserved bit in DCI or a target field in a paging message, where the target field includes at least one of the following: a paging field, a paging record field, or a paging terminal identifier.

In some embodiments, the first indication information is carried in at least one of the following manners:
a reserved bit in DCI in a broadcast form;
a reserved value in a short message indicator field in paging DCI; and
a paging message.

An embodiment of this application further provides a network side device, including a processor and a communication interface. The communication interface is configured to send first information to a terminal the first information indicates information related to sending of second information, and the second information indicates related information for assisting the network side device to save energy. The communication interface is further configured to receive the second information sent by the terminal. The network side device embodiment corresponds to the method embodiment of the network side device, each implementation process and implementation of the method embodiment can be applied to the network side device embodiment, and a same technical effect can be achieved.

For example, an embodiment of this application further provides a network side device. As shown in FIG. 9, the network side device 900 includes an antenna 71, a radio frequency apparatus 72, a baseband apparatus 73, a processor 74, and a memory 75. The antenna 71 is connected to the radio frequency apparatus 72. In an uplink direction, the radio frequency apparatus 72 receives information through the antenna 71, and sends the received information to the baseband apparatus 73 for processing. In a downlink direction, the baseband apparatus 73 processes information that needs to be sent, and sends processed information to the radio frequency apparatus 72. The radio frequency apparatus 72 processes the received information, and sends processed information through the antenna 71.

The foregoing band processing apparatus may be located in the baseband apparatus 73. In the foregoing embodiment, a method performed by the network side device may be implemented in the baseband apparatus 73. The baseband apparatus 73 includes a baseband processor and a memory 75.

For example, the baseband apparatus 73 may include at least one baseband board. Multiple chips are disposed on the baseband board. As shown in FIG. 9, one chip is, for example, a baseband processor, and is connected to the memory 75 through a bus interface, to invoke a program in the memory 75 to perform the operations of the network device shown in the foregoing method embodiment.

The baseband apparatus 73 of the network side device may further include a network interface 76, configured to exchange information with the radio frequency apparatus 72. For example, the interface is a Common Public Radio Interface (CPRI).

For example, the network side device 700 in this embodiment of this application further includes an instruction or a program that is stored in the memory 75 and that is executable on the processor 74. The processor 74 invokes the instruction or the program in the memory 75 to perform the method performed by the modules shown in FIG. 6, and a same technical effect is achieved. To avoid repetition, details are not described herein.

An embodiment of this application further provides a readable storage medium. The readable storage medium stores a program or an instruction, and the program or the instruction is executed by a processor to implement the processes of the foregoing embodiment of the uplink signal transmission method, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing embodiment of the uplink signal transmission method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the foregoing embodiment of the uplink signal transmission method, and a same technical effect can be achieved. To avoid repetition, details are not described herein again.

An embodiment of this application further provides a communication system, including a terminal and a network side device. The terminal may be configured to perform the steps of the foregoing uplink signal transmission method, and the network side device may be configured to perform the steps of the foregoing uplink signal transmission method.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is an example implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the method described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. An uplink signal transmission method, comprising:
receiving, by a terminal, first information delivered by a network side device, wherein the first information indicates information related to sending of second information, and the second information indicates related information for assisting the network side device to save energy; and
sending, by the terminal, the second information to the network side device based on the first information.

2. The uplink signal transmission method according to claim 1, wherein the first information comprises at least one of the following information:
grouping information of the terminal;
first indication information, wherein the first indication information is used to trigger sending of the second information to the network side device;
sending configuration information of the second information;
power headroom of the network side device;
a signal transmission power of the network side device;
a decision threshold of a measurement result;
a target value range of the measurement result;
geographical location information; or
at least one first parameter, wherein
the first parameter is used to determine the terminal sending the second information, the grouping information comprises at least one of the following:
a group identifier (ID), an area ID, or a Synchronization Signal/PBCH Block (SSB) index.

3. The uplink signal transmission method according to claim 2, wherein the grouping information is determined based on at least one of the following:
grouping based on a terminal ID;
grouping based on a distance between the terminal and the network side device;
grouping based on a measurement result of the terminal; or
grouping based on the SSB index.

4. The uplink signal transmission method according to claim 2, wherein the sending, by the terminal, the second information to the network side device based on the first information comprises:
sending, by the terminal, the second information to the network side device when the terminal fulfills a first condition, wherein the first condition comprises at least one of the following:
the terminal learns that a working state of the network side device fulfills a second condition, wherein the second condition is that the working state of the network side device is to change from a non-energy-saving state to an energy-saving state or a state of the network side device is an energy-saving state;
the terminal receives the first information;
a first field is present in the first information received by the terminal, wherein the first field carries the grouping information;
a second field is present in the first information received by the terminal, wherein the second field carries the first indication information;
the terminal determines that grouping information carried in the first information comprises the grouping information of the terminal;
a result of comparison between a measurement result of a latest measurement performed by the terminal and the decision threshold fulfills a third condition;
the measurement result of the latest measurement performed by the terminal is within the target value range of the measurement result;
a result of comparison between a measurement result of X1 continuous measurements performed by the terminal and the decision threshold fulfills a third condition, wherein X1 is an integer greater than 0;
a measurement result of X2 continuous measurements performed by the terminal is within the target value range of the measurement result, wherein X2 is an integer greater than 0;
a quantity of times or a proportion that a result of comparison between a measurement result of a measurement performed by the terminal within a first target time range and the decision threshold fulfills the third condition is greater than or equal to a first threshold;
a quantity of times or a proportion that a measurement result of a measurement performed by the terminal within a second target time range is within the target value range of the measurement result is greater than or equal to a second threshold;
m is a value obtained by performing a modulo operation on a terminal ID and k, and m and k are respective values when a quantity of the at least one first parameter is two;
a geographical location of the terminal is within a range of the geographical location information comprised in the first information;
a neighboring cell accessible to the terminal is absent; or
a neighboring cell fulfilling an access condition of the terminal is absent.

5. The uplink signal transmission method according to claim 2, wherein the sending configuration information of the second information comprises at least one of the following:
a minimum time interval between receiving time of the first information and sending time of the second information;
a quantity of times for repeatedly sending the second information;
a sending periodicity of the second information; or
a target sending signal strength of the second information.

6. The uplink signal transmission method according to claim 1, wherein
the second information carries at least one of the following:
wake-up indication information, wherein the wake-up indication information indicates whether to wake up the network side device in an energy-saving state;
a terminal ID;
location information of the terminal;
a signal transmission power that is of the network side device and that is expected by the terminal;
a transmit beam that is of the network side device and that is expected by the terminal;
a transmission power of the terminal;
service-related information; or
user experience-related information, wherein
the service-related information comprises at least one of the following: a Packet Delay Budget (PDB), a data packet size, a service cycle, or a priority, and the user experience-related information comprises at least one of the following: a transmission delay, a throughput, or an experience rate.

7. An uplink signal transmission method, comprising:
sending, by a network side device, first information to a terminal, wherein the first information indicates information related to sending of second information, and the second information indicates related information for assisting the network side device to save energy; and
receiving, by the network side device, the second information sent by the terminal.

8. The uplink signal transmission method according to claim 7, wherein the sending, by the network side device, the first information to a terminal comprises at least one of the following:
periodically sending, by the network side device, the first information;
sending, by the network side device, the first information within a target time domain position range;
in X4 time units before a working state of the network side device changes to an energy-saving state, triggering N1 times of sending the first information, wherein X4 and N1 are integers greater than or equal to 0;
in X3 time units after the working state of the network side device changes to the energy-saving state, triggering N2 times of sending the first information, wherein X3 and N2 are integers greater than or equal to 0;
starting sending the first information when a signal transmission power of the network side device is less than or equal to a first power threshold; or
starting sending the first information when a quantity of target units disabled by the network side device is less than or equal to a first quantity threshold, wherein the target unit comprises at least one of the following: an antenna element, a transceiver unit (TxRU), an antenna port, or a Transmission Reception Point (TRP).

9. The uplink signal transmission method according to claim 7, wherein after the receiving, by the network side device, the second information sent by the terminal, the method further comprises:
executing, by the network side device, a target behavior, wherein the target behavior comprises at least one of the following:
adjusting a working state, wherein the working state comprises at least one of the following: a sleep state, the energy-saving state, a normal state, or a non-energy-saving state;
adjusting a signal transmission power; or
stopping sending the first information.

10. The uplink signal transmission method according to claim 9, wherein the stopping, by the network side device, sending the first information comprises:
stopping, by the network side device, sending the first information when at least one of the following conditions is fulfilled:
the first information is sent continuously for first duration or M1 times, and the second information is not received;
the second information is received; or
the first information is sent repeatedly N3 times.

11. The uplink signal transmission method according to claim 9, wherein the executing, by the network side device, a target behavior comprises:
executing, by the network side device, the target behavior in a case that the following condition is fulfilled:
the network side device receives second information sent by any terminal;
the network side device receives the second information greater than or equal to M2 times within second duration;
a quantity of times that the network side device receives second information from a same terminal within third duration is greater than or equal to M3 times; or
the network side device receives second information from greater than or equal to M4 different terminals within fourth duration.

12. The uplink signal transmission method according to claim 7, wherein the first information comprises at least one of the following information:
grouping information of the terminal;
first indication information, wherein the first indication information is used to trigger sending of the second information to the network side device;
sending configuration information of the second information;
power headroom of the network side device;
the signal transmission power of the network side device;
a decision threshold of a measurement result;
a target value range of the measurement result;
geographical location information; or
at least one first parameter, wherein the first parameter is used to determine the terminal sending the second information.

13. The uplink signal transmission method according to claim 12, wherein the grouping information comprises at least one of the following:
a group identifier ID, an area ID, or a synchronization signal/PBCH block (SSB) index.

14. The uplink signal transmission method according to claim 12, wherein the grouping information is determined based on at least one of the following:
grouping based on a terminal ID;
grouping based on a distance between the terminal and the network side device;
grouping based on a measurement result of the terminal; or
grouping based on an SSB index.

15. The uplink signal transmission method according to claim 12, wherein the sending configuration information of the second information comprises at least one of the following:
a minimum time interval between receiving time of the first information and sending time of the second information;
a quantity of times for repeatedly sending the second information;
a sending periodicity of the second information; or
a target sending signal strength of the second information.

16. The uplink signal transmission method according to claim 7, wherein
the second information carries at least one of the following:
wake-up indication information, wherein the wake-up indication information indicates whether to wake up the network side device in the energy-saving state;
a terminal ID;
location information of the terminal;
a signal transmission power that is of the network side device and that is expected by the terminal;
a transmit beam that is of the network side device and that is expected by the terminal;
a transmission power of the terminal;
service-related information; or
user experience-related information, wherein
the service-related information comprises at least one of the following: a Packet Delay Budget (PDB), a data packet size, a service cycle, or a priority, and the user experience-related information comprises at least one of the following: a transmission delay, a throughput, or an experience rate.

17. A terminal, comprising a processor and a memory storing instructions, wherein the instructions, when executed by the processor, cause the processor to perform operations comprising:
receiving first information delivered by a network side device, wherein the first information indicates information related to sending of second information, and the second information indicates related information for assisting the network side device to save energy; and
sending the second information to the network side device based on the first information.

18. A network side device, comprising a processor and a memory storing instructions, wherein the instructions, when executed by the processor, cause the processor to perform the uplink signal transmission method according to claim 7.

19. A non-transitory computer readable storage medium storing instructions, that, when executed by a processor, cause the processor to perform the uplink signal transmission method according to claim 1.

20. A non-transitory computer readable storage medium storing instructions, that, when executed by a processor, cause the processor to perform the uplink signal transmission method according to claim 7.
